(19) United States
(12) Patent Application Publication
(10) Pub. No.: US 2022/0371368 A1
(43) Pub. Date: Nov. 24, 2022

(54) PNEUMATIC TIRE

(71) Applicant: The Yokohama Rubber Co., LTD., Tokyo (JP)

(72) Inventors: Tatsuro SHINZAWA, Kanagawa (JP); Atsuhito NAKANO, Kanagawa (JP); Kenta HOMMA, Kanagawa (JP)

(21) Appl. No.: 17/754,975

(22) PCT Filed: Sep. 7, 2020
(86) PCT No.: PCT/JP2020/033838

§ 371 Date: Apr. 18, 2022

(30) Foreign Application Priority Data
Oct. 21, 2019 (JP) 2019-191901

(51) Int. Cl. B60C 9/00; B60C 11/04

(52) U.S. Cl. CPC B60C 9/0042; B60C 11/04; B60C 2009/0035; B60C 2009/0078

(57) ABSTRACT

A pneumatic tire includes at least one carcass layer between bead portions on an inner side in a radial direction of sidewall portions on both sides of a tread portion extending in a circumferential direction and having an annular shape, and the carcass layer includes carcass cords formed of organic fiber cords obtained by intertwining a filament bundle of organic fibers. The carcass layer includes turn-up portions formed by being turned back at an end portion of the bead portions to an outer side in a tire width direction. The carcass cords have an elongation at break EB satisfying EB≥15%, a cap tread rubber compound of the tread portion has a 300% modulus MD satisfying 4 MPa≤MD≤13 MPa, and the elongation at break EB and the 300% modulus MD satisfy 600≤40×MD+20×EB (%)≤1300.

### TECHNICAL FIELD

The present technology relates to a pneumatic tire including a carcass layer including organic fiber cords.

### BACKGROUND ART

Some pneumatic tires include carcass plies spanning between a pair of bead portions (see Japan Unexamined Patent Publication Nos. 2015-231772 and 2015-231773). One cause of failure of a pneumatic tire including carcass plies is damage (shock burst) inflicted on the tire due to a large shock to the tire during travel, leading to breakage of the carcass plies inside the tire.

For example, durability against such damage (shock burst resistance) may be determined by, for example, a plunger test. The plunger test is a test for measuring breaking energy generated when a tire is broken by pressing of a plunger of a predetermined size against a central portion of the tread on a tire surface. Thus, the plunger test can be used as an indicator of the breaking energy (breaking durability against projection input to the tread portion) when the tire climbs over projections on an uneven road surface.

Rayon fiber cords formed from rayon materials having high rigidity have often been used as carcass cords constituting carcass plies for high-performance vehicle tires. However, in recent years, due to an increased maximum speed of the vehicle, a demanded weight reduction, and a demanded high grip, the gauge, hardness, and modulus of the rubber (cap tread rubber) of the ground contact portion of the tire have tended to decrease. This results in insufficient elongation at break of the carcass plies and reduced shock burst resistance. This leads to difficult provision of both shock burst resistance and traveling stability with an increased maximum speed of the vehicle, a demanded weight reduction, and a demanded high grip in a compatible manner.

### SUMMARY

The present technology provides a pneumatic tire that provides both steering stability and shock burst resistance on dry road surfaces in a compatible manner by properly using organic fiber cords formed from organic fibers having rigidity comparable to that of rayon materials and having large elongation at break.

An embodiment of the present technology provides a pneumatic tire including a tread portion extending in a tire circumferential direction and having an annular shape, a pair of sidewall portions respectively disposed on both sides of the tread portion, a pair of bead portions each disposed on an inner side of the sidewall portion in a tire radial direction, and at least one carcass layer spanning between the pair of bead portions, the carcass layer including carcass cords formed of organic fiber cords obtained by intertwining a bundle of filaments of organic fibers, and including turn-up portions respectively formed by being turned back at an end portion of the pair of bead portions to an outer side in a tire width direction, the carcass cord having an elongation at break EB of 15% or more, a cap tread rubber compound of the tread portion having a 300% modulus MD of 4 MPa≤MD≤13 MPa, and the elongation at break EB and the 300% modulus MD being such that 600≤40×MD+20×EB (%)≤1300.

Additionally, preferably, the pneumatic tire described above further includes a plurality of belt layers disposed on an outer side of the carcass layer in the tire radial direction, where the tread portion includes a pair of center main grooves extending in the tire circumferential direction with a tire equator line interposed between the center main grooves, and a center land portion defined by the pair of center main grooves, and the center land portion located within 10% of a width of a second widest belt of the belt layers on each of a left side and a right side of a tire equatorial plane in the tire width direction has an average total gauge GC of satisfying 5 mm≤GC≤10 mm, and the average total gauge GC, the 300% modulus MD, and the elongation at break EB satisfy 1100≤60×GC+40×MD+20×EB≤1600.

Additionally, in the pneumatic tire described above, preferably the carcass cords have, under a load of 1.0 cN/dtex, an intermediate elongation EM satisfying EM≤5.0%.

Additionally, in the pneumatic tire described above, preferably, the carcass cords have a standard amount fineness CF satisfying 4000 dtex≤CF≤8000 dtex.

Additionally, in the pneumatic tire described above, preferably, the carcass cords have, after dip treatment, a twist coefficient CT satisfying CT≥2000 (T/dm)×dtex^{0.5}.

The pneumatic tire according to an embodiment of the present technology achieves the effect of allowing provision of both steering stability and shock burst resistance on dry road surfaces in a compatible manner.

### BRIEF DESCRIPTION OF DRAWINGS

FIG. 1 is a meridian cross-sectional view illustrating a main portion of a pneumatic tire according to an embodiment of the present technology.

FIG. 2 is a side view illustrating a vehicle on which pneumatic tires according to an embodiment of the present technology are mounted.

FIG. 3 is a diagram of a vehicle on which pneumatic tires according to an embodiment of the present technology are mounted as viewed from behind the vehicle.

### DETAILED DESCRIPTION

Pneumatic tires according to embodiments of the present technology are described in detail below with reference to the drawings. However, the present technology is not limited by the embodiment. Constituents of the following embodiments include elements that are essentially identical or that can be substituted or easily conceived of by a person skilled in the art.

### EMBODIMENTS

### Pneumatic Tire

Hereinafter, “tire radial direction” refers to the direction orthogonal to a tire rotation axis RX corresponding to the rotation axis of a pneumatic tire 1. “Inner side in the tire radial direction” refers to the side toward the tire rotation axis RX in the tire radial direction. “Outer side in the tire radial direction” refers to the side away from the tire rotation axis RX in the tire radial direction. The term “tire circumferential direction” refers to a circumferential direction with the tire rotation axis RX as a center axis. Additionally, a tire equatorial plane CL is a plane that is orthogonal to the tire rotation axis RX and that passes through the center of the tire width of the pneumatic tire 1. The position of the tire equatorial plane CL in the tire width direction aligns with the center line in the tire width direction corresponding to the center position of the pneumatic tire 1 in the tire width direction. “Tire equator line” refers to a line in the tire circumferential direction of the pneumatic tire 1 that lies on the tire equatorial plane CL. Additionally, “tire width direction” refers to the direction parallel with the tire rotation axis RX. The term “inner side in the tire width direction” refers to the side toward the tire equatorial plane (tire equator line) CL in the tire width direction. The term “outer side in the tire width direction” refers to the side away from the tire equatorial plane CL in the tire width direction. The tire width is the width in the tire width direction between portions located on the outermost sides in the tire width direction. In other words, the tire width is the distance between portions that are the most distant from the tire equatorial plane CL in the tire width direction.

In the present embodiment, the pneumatic tire 1 is a tire for a passenger vehicle. The term “tire for a passenger vehicle” refers to a tire specified in Chapter A of the JATMA YEAR BOOK (standards of The Japan Automobile Tyre Manufacturers Association, Inc.). In the present embodiment, a tire for a passenger vehicle will be described, but the pneumatic tire 1 may be a tire for a small truck defined in Chapter B. or may be a tire for a truck and a bus defined in Chapter C. Additionally, the pneumatic tire 1 may be a normal tire (summer tire) or a studless tire (winter tire).

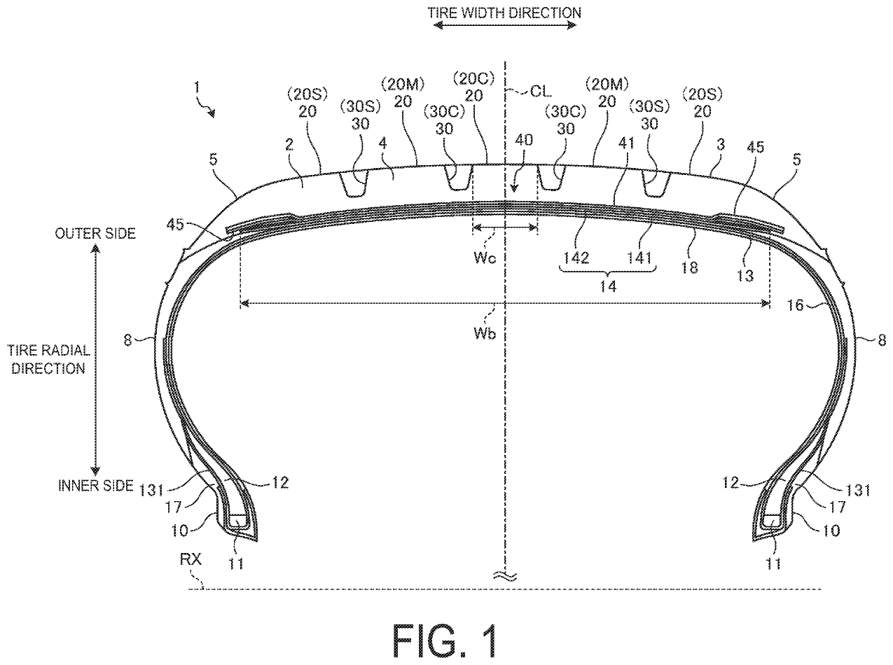

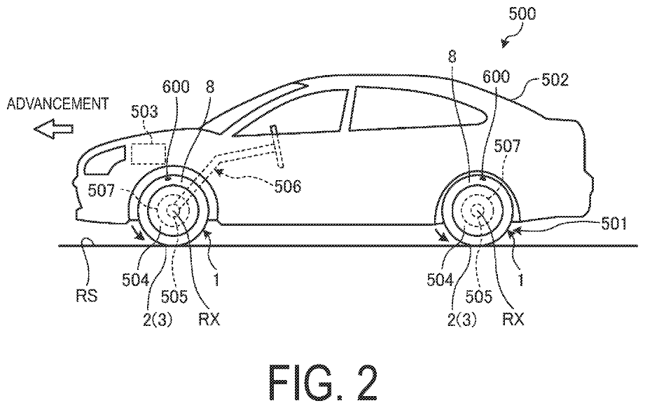

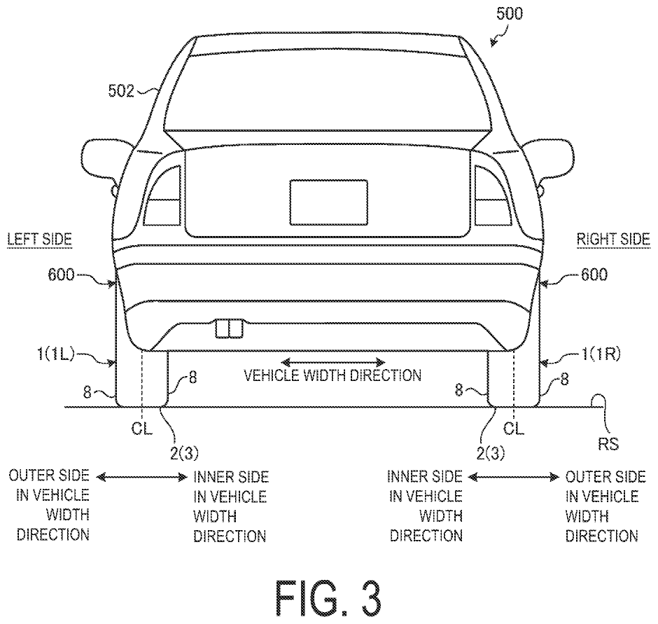

FIG. 1 is a meridian cross-sectional view illustrating a main portion of the pneumatic tire 1 according to a first embodiment. The term “meridian cross-section” refers to a cross section orthogonal to the tire equatorial plane CL. FIG. 2 is a side view illustrating a vehicle 500 on which the pneumatic tires 1 according to the present embodiment are mounted. FIG. 3 is a diagram of the vehicle 500 on which the pneumatic tires 1 according to the present embodiment are mounted as viewed from behind the vehicle 500. The pneumatic tire 1 according to the present embodiment mounted on a rim of a wheel 504 of the vehicle 500 illustrated in FIGS. 2 and 3 rotates around the tire rotation axis Rx.

In the pneumatic tire 1 according to the present embodiment, as viewed in a tire meridian cross-section, a tread portion 2 extending in the tire circumferential direction and having an annular shape is disposed at the outermost portion in the tire radial direction. The tread portion 2 includes a tread rubber layer 4 formed of a rubber composition. Additionally, a surface of the tread portion 2, that is, a portion that comes into contact with road surfaces during traveling of the vehicle 500 on which the pneumatic tires 1 are mounted is formed as a tread contact surface 3, and the tread contact surface 3 forms a portion of a contour of the pneumatic tire 1. Specifically, cap tread rubber corresponds to the tread rubber layer 4 on the inner side of the tread contact surface 3 in the tire radial direction.

The tread contact surface 3 of the tread portion 2 is provided with a plurality of circumferential main grooves 30 extending in the tire circumferential direction and a plurality of lug grooves (not illustrated) extending in the tire width direction. The term “circumferential main groove 30” refers to a groove extending in the tire circumferential direction and including a tread wear indicator (slip sign) inside. The tread wear indicator indicates the terminal stage of wear of the tread portion 2. The circumferential main groove 30 has a width of 4.0 mm or more and a depth of 5.0 mm or more. Note that “lug groove” refers to a groove at least partially extending in the tire width direction. The lug groove has a width of 1.5 mm or more and a depth of 4.0 mm or more. Note that the lug grooves may partly have a depth of less than 4.0 mm.

The circumferential main groove 30 may linearly extend in the tire circumferential direction, or may form a wave shape or a zigzag shape in the tire width direction while extending in the tire circumferential direction. Additionally, the lug grooves may also extend linearly in the tire width direction, may be inclined in the tire circumferential direction while extending in the tire width direction, or may be bent or curved in the tire circumferential direction while extending in the tire width direction.

Additionally, the tread contact surface 3 of the tread portion 2 includes a plurality of land portions 20 by the circumferential main grooves 30 and lug grooves. In the present embodiment, four of the circumferential main grooves 30 are formed parallel in the tire width direction. Additionally, of two of the circumferential main grooves 30 disposed in one of a left region and a right region demarcated by the tire equatorial plane CL, the circumferential main groove 30 located on the outermost side in the tire width direction (outermost circumferential main groove) is defined as a shoulder main groove 30S, and the circumferential main groove 22 located on the innermost side in the tire width direction (innermost circumferential main groove) is defined as a center main groove 30C. The shoulder main groove 30S and the center main groove 30C are defined in each of the left and right regions demarcated by the tire equatorial plane CL.

Of the plurality of land portions 20 defined by the circumferential main grooves 30, the land portion 20 located further on the outer side than the shoulder main groove 30S in the tire width direction is defined as a shoulder land portion 20S, the land portion 20 between the shoulder main groove 30S and the center main groove 30C is defined as a middle land portion 20M, and the land portion 20 located further on the inner side of the center main groove 30C in the tire width direction is defined as a center land portion 20C. Specifically, of the plurality of land portions 20 on the surface of the tread portion 2, the land portion 20 on the outermost side in the tire width direction is defined as the shoulder land portion 20S, and the land portion 20 on the innermost side in the tire width direction is defined as the center land portion 20C. The center land portion 20C includes a tire equatorial plane (tire equator line) CL in the tire width direction.

Shoulder portions 5 are respectively positioned at both ends on outer sides of the tread portion 2 in the tire width direction (positioned further on the outer side than the shoulder land portion 20S), a pair of sidewall portions 8 are disposed on the inner side of the respective shoulder portion 5 in the tire radial direction. In other words, the pair of sidewall portions 8 are respectively disposed on both sides in the tire width direction of the tread portion 2. The sidewall portions 8 are thus formed form outermost exposed portions of the pneumatic tire 1 in the tire width direction.

Bead portions 10 are respectively disposed on the inner side of the pair of sidewall portion 2 in the tire radial direction. The bead portions 10 are respectively arranged at two locations on both sides of the tire equatorial plane CL. In other words, a pair of the bead portions 10 are respectively disposed on both sides of the tire equatorial plane CL in the tire width direction.

The pair of bead portions 10 are each provided with a bead core 11, and a bead filler 12 is provided on the outer side of the bead core 11 in the tire radial direction. The bead core 11 is an annular member formed in an annular shape by bundling bead wires which are steel wires. The bead filler 12 is a rubber member disposed on the outer side of the bead core 11 in the tire radial direction.

Additionally, a belt layer 14 is disposed in the tread portion 2. The belt layer 14 has a multilayer structure in which a plurality of belts 141 and 142 are stacked. The belts 141, 142 constituting the belt layer 14 are formed by covering, with coating rubber, a plurality of belt cords made of steel or an organic fiber material, such as polyester, rayon, or nylon, and performing a rolling process thereon, and a belt angle defined as an inclination angle of the belt cords with respect to the tire circumferential direction is within a predetermined range (for example, of 20° or more and 55° or less).

Furthermore, the belt angles of the two layers of the belts 141, 142 differ from each another. Accordingly, the belt layer 14 is configured as a so-called crossply structure in which the two layers of the belts 141, 142 are layered with the inclination directions of the belt cords intersecting with each another. In other words, the two belts 141, 142 are provided as so-called a pair of cross belts in which the belt cords of the respective belts 141, 142 are disposed in mutually intersecting orientations.

A belt cover 40 is disposed on the outer side of the belt layer 14 in the tire radial direction. The belt cover 40 is disposed on the outer side of the belt layer 14 in the tire radial direction, covers the belt laver 14 in the tire circumferential direction, and is provided as a reinforcing layer that reinforces the belt layer 14. The belt cover 40 has a width in the tire width direction that is greater than the width of the belt layer 14 in the tire width direction, and covers the belt layer 14 from the outer side in the tire radial direction. The belt cover 40 is disposed across the entire range in the tire width direction in which the belt layer 14 is disposed and covers end portions of the belt layer 14 in the tire width direction. The tread rubber layer 4 of the tread portion 2 is disposed on the outer side of the belt cover 40 in the tread portion 2 in the tire radial direction.

Additionally, the belt cover 40 includes: a full cover portion 41 that is identical to the belt cover 40 in the width in the tire width direction and edge cover portions 45 stacked on the full cover portion 41 at two respective locations on both sides of the full cover portion 41 in the tire width direction. Of the two edge cover portions 45, one edge cover portion 45 is located on the inner side of the full cover portion 41 in the tire radial direction, and the other edge cover portion 45 is located on the outer side of the full cover portion 41 in the tire radial direction.

A carcass layer 13 is continuously provided on the inner side of the belt layer 14 in the tire radial direction and on the tire equatorial plane CL side of the sidewall portion 8. In the present embodiment, the carcass layer 13 has a single layer structure made of one carcass ply or a multilayer structure made of a plurality of carcass plies being layered, and spans in a toroidal shape between the pair of bead portions 10 respectively disposed on both sides in the tire width direction, forming the framework of the tire.

Specifically, the carcass layer 13 is disposed to span from one bead portion 10 to the other bead portion 10 among the bead portions 10 located on both sides in the tire width direction and is turned up toward the outer side in the tire width direction along the bead cores 11 at the bead portions 10 so as to wrap around the bead cores 11 and the bead fillers 12. The bead filler 12 is a rubber member disposed in a space formed on the outer side of the bead core 11 in the tire radial direction when the carcass layer 13 is turned up at the bead core 11 of the bead portion 10.

Additionally, in the bead portion 10, a rim cushion rubber 17 forming a contact surface of the bead portion 10 for a rim flange (not illustrated) is disposed on the inner side in the tire radial direction and on the outer side in the tire width direction of the bead core 11 and a turn-up portion 131 (turned back portion) of the carcass layer 13. The pair of rim cushion rubbers 17 extend from the inner side in the tire radial direction toward the outer side in the tire width direction of the left and right bead cores 11 and turn-up portions 131 of the carcass layer 13, and constitute rim fitting surfaces of the bead portions 10. Moreover, the belt layer 14 is disposed on the outer side in the tire radial direction of a portion, located in the tread portion 2, of the carcass layer 13 spanning between the pair of bead portions 10.

Additionally, the carcass ply of the carcass layer 13 is formed by covering, with coating rubber, a plurality of carcass cords made from organic fibers and performing a rolling process thereon. The plurality of carcass cords that form the carcass ply are disposed side by side with an angle in the tire circumferential direction, the angle with respect to the tire circumferential direction following a tire meridian direction.

In the present embodiment, the carcass layer 13 includes at least one carcass ply (textile carcass) including organic fiber cords (textile cords). The carcass layer 13 of the present embodiment includes the turn-up portion 131 on both end portions. The carcass layer 13 includes at least one textile carcass wound around the bead cores 11 respectively provided in the pair of bead portions 10.

The carcass cords forming the carcass ply of the carcass layer 13 are organic fiber cords including filament bundles of organic fibers intertwined together. The type of organic fibers constituting the carcass cords is not particularly limited, and for example, polyester fibers, nylon fibers, aramid fibers, or the like can be used. Polyester fibers can be suitably used as the organic fibers. The polyester fibers that can be used include, for example, polyethylene terephthalate (PET), polybutylene terephthalate (PBT), and polybutylene naphthalate (PBN), and the like. As the polyester fibers, polyethylene terephthalate (PET) can be suitably used.

Additionally, an innerliner 16 is formed along the carcass layer 13 on the inner side of the carcass layer 13 or on the inner portion side of the carcass layer 13 in the pneumatic tire 1. The innerliner 16 is an air penetration preventing layer disposed in a tire inner circumferential surface and covering the carcass layer 13, and the innerliner 16 suppresses oxidation due to exposure of the carcass layer 13 and additionally prevents leakage of air inside the tire. Additionally, the innerliner 16 includes, for example, a rubber composition containing butyl rubber as a main component, a thermoplastic resin, a thermoplastic elastomer composition containing an elastomer component blended with the thermoplastic resin, and the like. The innerliner 16 forms a tire inner surface 18 that is a surface on the inner side of the pneumatic tire 1.

### Vehicle Mounting Position

As illustrated in FIGS. 2 and 3, the vehicle 500 includes a driving apparatus 501 including the pneumatic tire 1, a vehicle body 502 supported by the driving apparatus 501, and an engine 503 for driving the driving apparatus 501. The driving apparatus 501 includes the wheel 504 that supports the pneumatic tire 1, an axle 505 that supports the wheel 504, a steering apparatus 506 for changing the advancement direction of the driving apparatus 501, and a brake apparatus 507 for decelerating or stopping the driving apparatus 501.

The vehicle body 502 includes a driver cab occupied by a driver. Disposed in the driver cab are: the accelerator pedal used to adjust the output of the engine 503; the brake pedal used to actuate the brake apparatus 507; and the steering wheel used to operate the steering apparatus 506. The driver operates the accelerator pedal, the brake pedal, and the steering wheel. The driver performs operation to cause the vehicle 500 to travel.

The pneumatic tire 1 is mounted on a rim of the wheel 504 of the vehicle 500. Then, with the pneumatic tire 1 mounted on the rim, the inside of the pneumatic tire 1 is filled with air. By filling the inside of the pneumatic tire 1 with air, the pneumatic tire 1 is inflated. The term “inflated state of the pneumatic tire 1” refers to the state in which the pneumatic tire 1 mounted on a specified rim is filled with air to a specified internal pressure.

“Specified rim” refers to a rim defined for each pneumatic tire 1 by standards for the pneumatic tire 1, and includes a “Standard Rim” defined by JATMA, a “Design Rim” defined by TRA (The Tire and Rim Association, Inc.), and a “Measuring Rim” defined by ETRTO (The European Tyre and Rim Technical Organisation).

“Specified internal pressure” refers to an air pressure defined for each pneumatic tire 1 by the standards for the pneumatic tire 1, and includes the “maximum air pressure” defined by JATMA, the maximum value in the table “TIRE LOAD LIMITS AT VARIOUS COLD INFLATION PRESSURES” defined by TRA, and the “INFLATION PRESSURE” defined by ETRTO. In JATMA, for tires for a passenger vehicle, the specified internal pressure is an air pressure of 180 kPa.

Additionally, “non-inflated state of the pneumatic tire 1” refers to a state in which the pneumatic tire 1 mounted on the specified rim is filled with no air. In the non-inflated state, the internal pressure of the pneumatic tire 1 is atmospheric pressure. In other words, in the non-inflated state, the internal pressure and the external pressure of the pneumatic tire 1 are substantially equal.

The pneumatic tire 1 mounted on the rim of the vehicle 500 rotates around the tire rotation axis RX and travels on a road surface RS. During traveling of the pneumatic tire 1, the tread contact surface 3 of the tread portion 2 contacts the road surface RS.

In a loaded state of the pneumatic tire 1 being mounted on a specified rim, inflated to the specified internal pressure, and placed vertically on a flat surface, and a specified load being applied to the pneumatic tire 1, “tire ground contact edges” refer to end portions in the tire width direction of a portion (tread contact surface 3) of the tread portion 2 coming into contact with the ground. The shoulder land portions 20S of the tread portion 2 are land portions 20 located on the outermost side in the tire width direction and on the tire ground contact edge.

“Specified load” refers to a load defined for each tire by the standards for the pneumatic tire 1, and includes the “maximum load capacity” defined by JATMA, the maximum value in the table “TIRE LOAD LIMITS AT VARIOUS COLD INFLATION PRESSURES” defined by TRA, and “LOAD CAPACITY” defined by ETRTO. However, when the pneumatic tire 1 is for a passenger vehicle, the load is assumed to correspond to 88% of the load.

The vehicle 500 is a four-wheeled vehicle. The driving apparatus 501 includes a left front wheel and a left rear wheel provided on the left side of the vehicle body 502 and a right front wheel and a right rear wheel provided on the right side of the vehicle body 502. The pneumatic tire 1 includes left pneumatic tires 1L mounted on the left side of the vehicle body 502 and right pneumatic tires 1R mounted on the right side of the vehicle body 502.

In the following description, “inner side in the vehicle width direction” refers as appropriate to a portion near the center of the vehicle 500 or a direction approaching the center of the vehicle 500 in the vehicle width direction of the vehicle 500. “Outer side in the vehicle width direction” refers as appropriate to a portion far from the center of the vehicle 500 or a direction leaving the center of the vehicle 500 in the vehicle width direction of the vehicle 500.

The present embodiment designates the mounting direction of the pneumatic tire 1 with respect to the vehicle 500. For example, in a case where the tread pattern of the tread portion 2 is an asymmetrical pattern, the mounting direction of the pneumatic tire 1 with respect to the vehicle 500 is designated. The left pneumatic tire 1L is mounted on the left side of the vehicle 500 such that one designated sidewall portion 8 of the pair of sidewall portions 8 faces the inner side in the vehicle width direction and the other sidewall portion 8 faces the outer side in the vehicle width direction. The right pneumatic tire 1R is mounted on the right side of the vehicle 500 such that one designated sidewall portion 8 of the pair of sidewall portions 8 faces the inner side in the vehicle width direction and the other sidewall portion 8 faces the outer side in the vehicle width direction.

In a case where a tire mounting direction with respect to the vehicle 500 is designated, the pneumatic tire 1 is provided with an indicator portion 600 indicating the designated mounting direction with respect to the vehicle 500. The indicator portion 600 is provided on at least one sidewall portion 8 of the pair of sidewall portions 8. The indicator portion 600 includes a serial symbol indicating the mounting direction with respect to the vehicle 500. The indicator portion 600 includes at least one of a mark, characters, a sign, and a pattern. An example of the indicator portion 600 indicating the mounting direction of the pneumatic tire 1 with respect to the vehicle 500 includes characters such as “OUTSIDE” or “INSIDE.” The user can recognize the mounting direction of the pneumatic tire 1 with respect to the vehicle 500 based on the indicator portion 600 provided on the sidewall portion 8. Based on the indicator portion 600, the left pneumatic tires 1L are mounted on the left side of the vehicle 500, and the right pneumatic tires 1R are mounted on the right side of the vehicle 500.

The pneumatic tire 1 of the present embodiment satisfies the following conditions. Specifically, elongation at break EB (%) of the carcass cords of the carcass layer 13 satisfies EB≥15%. The elongation at break EB of the carcass cords is physical properties sampled from the side portions of the pneumatic tire 1. Additionally, in the pneumatic tire 1, a cap tread rubber (CAP) compound has a 300% modulus MD satisfying 4 MPa≤MD≤13 MPa.

With each of the conditions described above satisfied, the elongation at break EB and the 300% modulus MD of the CAP compound satisfy the following conditions. In this regard, the elongation at break EB is a value expressed as a percentage, and in a case where the elongation at break is 15%. EB (%) in Formula (1) is 15.

600≤40×MD+20×EB (%)≤1300 (1)

The pneumatic tire 1 preferably satisfies EB≥20%. Additionally, the modulus MD preferably satisfies 6 MPa≤MD≤12 MPa.

In the pneumatic tire 1, in a case where the 300% modulus MD of the CAP compound and the elongation at break EB of the carcass cords are within the range described above, and the 300% modulus MD of the CAP compound and the elongation at break EB of the carcass cords satisfy Formula (1) described above, the grip performance of the pneumatic tire 1 on dry road surfaces is improved, allowing high shock burst resistance to be maintained, while improving steering stability. This allows both steering stability and shock burst resistance of the pneumatic tire 1 on dry road surfaces to be provided in a compatible manner.

Additionally, in the pneumatic tire 1, the center land portion 20C located within 10% (10% on each left and right, that is, a total of 20%) of a width Wb of the second widest belt (hereinafter referred to as the second belt) of the belt layer 14 on each of the left and right sides of the tire equatorial plane CL in the tire width direction has an average total gauge GC, of the tread rubber layer 4, satisfying 5 mm≤GC≤10 mm.

In the present embodiment, in the belt layer 14, the widest belt is the belt 141, and the second belt is the belt 142. In the present embodiment, only the belts 141, 142 are illustrated, in other words, the second belt is a belt having the narrowest width (the narrowest belt) in the belt layer 14. In the conditions described above, a width Wc of the center land portion 20C in the tire width direction is 20% of the width Wb of the belt 142 corresponding to the second belt. In other words, Wc=0.2×Wb is satisfied.

Furthermore, in the pneumatic tire 1, the average total gauge GC of the center land portion 20C, the 300% modulus MD of the CAP compound, and the elongation at break EB of the carcass cords satisfy the condition of Formula (2).

1100≤60×GC+40×MD+20×EB(%)≤1600 (2)

With the pneumatic tire 1, by setting the average total gauge GC, the 300% modulus MD of the CAP compound, and the elongation at break EB of the carcass cords such that the conditions described above are satisfied, the steering stability and shock burst resistance of the pneumatic tire 1 on the dry road surfaces can be provided at a higher level in a compatible manner. In other words, in a case where the total gauge of the center land portion 20C is set within the range described above, with the shock burst resistance increased, a situation can be suppressed in which an excessively increased thickness promotes accumulation of heat in the tread portion 2, leading to loss of grip due to heat, causing degraded steering stability.

Additionally, the carcass cords preferably have, under a load of 1.0 cN/dtex (nominal fineness), an intermediate elongation EM satisfying EM≤5.0%. Additionally, a nominal fineness NF of the carcass cords preferably satisfies 3500 dtex≤NF≤7000 dtex.

“Intermediate elongation under a load of 1.0 cN/dtex” refers to the elongation ratio (%) of sample cords measured under a load of 1.0 cN/dtex, the sample cords corresponding to the carcass cords removed from the sidewall portions 8 of the pneumatic tire 1, the sample cords being subjected to a tensile test at a length between grips of 250 mm and a tensile speed of 300±20 mm/minute in accordance with JIS (Japanese Industrial Standard) L1017 “Test Methods for Chemical FiberTire Cords.”

By reducing the intermediate elongation EM of the carcass cords while maintaining the elongation at break EB of the carcass cords, the steering stability on dry road surfaces can be improved with suppressing degradation of the shock burst resistance of the pneumatic tire 1.

Additionally, the carcass cords preferably have, after dip treatment, a standard amount fineness CF satisfying 4000 dtex≤CF≤8000 dtex. The standard amount fineness CF more preferably satisfies 5000 dtex≤CF≤7000 dtex.

“Standard amount fineness of the carcass cords after dip treatment” refers to the fineness measured after performing dip treatment on the carcass cords, and is not a value for the carcass cords themselves, but rather a value incorporating a dip liquid adhered to the carcass cords after dip treatment.

By setting the standard amount fineness CF of the carcass cords after dip treatment to be within the range described above, the intermediate elongation EM of the carcass cords can be reduced with the elongation at break EB of the carcass cords maintained, allowing both steering stability on dry road surfaces and shock burst resistance of the pneumatic tire 1 to be provided in a compatible manner.

Additionally, in the pneumatic tire 1, the carcass cords preferably have, after dip treatment, a twist coefficient CT satisfying CT≥2000 (T/dm)×dtex^{0.5}.

By setting the twist coefficient CT of the carcass cords after dip treatment within the range described above, the intermediate elongation EM of the carcass cords can be reduced with the elongation at break EB of the carcass cords maintained, allowing both steering stability on dry road surfaces and shock burst resistance of the pneumatic tire 1 can be provided in a compatible manner. In addition, by reducing the intermediate elongation EM of the carcass cords with the elongation at break EB of the carcass cords maintained, the carcass cords are made easy to elongate and difficult to cut.

### EXAMPLES

Tables 1 and 2 show results of performance tests of pneumatic tires according to the present embodiment. In the performance tests, a plurality of types of test tires having different conditions were evaluated for shock burst resistance and steering stability. In the performance tests, pneumatic tires (test tires) having a size of 265/35ZR20 were assembled on rims of 20×9.5 J, inflated to an air pressure of 200 kPa, and mounted on a test FF (front-engine, front-wheel-drive) sedan passenger vehicle (total engine displacement of 1600 cc).

For evaluation of shock burst resistance, a plunger test was conducted in accordance with FMVSS (Federal Motor Vehicle Safety Standard) 139. Evaluation of shock burst resistance was conducted using index values, with Conventional Example being assigned as the reference (100), with larger values being more preferable.

For evaluation of steering stability, tests related to steering stability on dry road surfaces were conducted using a 3L class European vehicle (sedan). Note that in the tests related to steering stability on dry road surfaces, the test vehicle was driven on a test course of a dry road surface including a flat circuit at a speed of 60 km/h or more and 100 km/h or less. Then, sensory evaluation was conducted by a test driver for steering characteristics during lane change and cornering as well as stability during straight traveling. The evaluation was conducted using index values, with Conventional Example being assigned as the reference (100), with larger values being more preferable.

In the pneumatic tire of Conventional Example, rayon fiber cords formed of rayon material having high rigidity were used as the carcass cords constituting the carcass ply. On the other hand, the pneumatic tires of Comparative Examples 1 to 5 and Examples 1 to 9 used, as the carcass cords constituting the carcass ply. PET fiber cords formed of polyethylene terephthalate material having rigidity comparable to that of rayon material and having a large elongation at break. These pneumatic tires were evaluated for shock burst resistance and steering stability by an evaluation method described below, and the results are also shown in Tables 1 and 2.

TABLE 1

| | Conventional | Comparative | Comparative | Comparative |
|---|---|---|---|---|
| | Example | Example 1 | Example 2 | Example 3 |
| Type of | Rayon | PET | PET | PET |
| organic fiber | | | | |
| material | | | | |
| Elongation at | 10 | 10 | 25 | 25 |
| break EB (%) | | | | |
| of carcass | | | | |
| cords | | | | |
| CAP 300% | 15 | 7 | 3 | 14 |
| Modulus MD | | | | |
| 40 × MD + | 800 | 480 | 620 | 1060 |
| 20 × EB | | | | |
| Shock burst | 100 | 70 | 80 | 100 |
| resistance | | | | |
| Steering | 100 | 120 | 90 | 110 |
| stability | | | | |
| | Comparative | Comparative | | |
| | Example 4 | Example 5 | Example 1 | Example 2 |
| Type of | PET | PET | PET | PET |
| organic fiber | | | | |
| material | | | | |
| Elongation at | 14 | 30 | 25 | 30 |
| break EB (%) | | | | |
| of carcass | | | | |
| cords | | | | |
| CAP 300% | 7 | 18 | 8 | 8 |
| Modulus MD | | | | |
| 40 × MD + | 560 | 1320 | 820 | 920 |
| 20 × EB | | | | |
| Shock burst | 80 | 130 | 100 | 120 |
| resistance | | | | |
| Steering | 120 | 80 | 120 | 130 |
| stability | | | | |

TABLE 2

| | EXAMPLE | EXAMPLE | EXAMPLE | EXAMPLE | EXAMPLE |
|---|---|---|---|---|---|
| | 1 | 2 | 3 | 4 | 5 |
| Type of organic fiber material | PET | PET | PET | PET | PET |
| Elongation at break EB (%) of | 25 | 30 | 3 0 | 30 | 30 |
| carcass cords | | | | | |
| CAP 300% Modulus MD | 8 | 8 | 8 | 8 | 8 |
| 40 × MD + 20 × EB | 820 | 920 | 920 | 920 | 920 |
| Average total gauge GC | 9.5 | 9.5 | 4 | 9.5 | 9.5 |
| 60 × GC + 40 × MD + 20 × EB | 1390 | 1490 | 1160 | 1490 | 1490 |
| Intermediate elongation EM | 6 | 4 | 6 | 6 | 4 |
| (%) of carcass cords | | | | | |
| Standard amount fineness CF | 3500 | 500 | 3500 | 3500 | 3500 |
| of carcass cords | | | | | |
| Twist coefficient CT ofcarcass | 1500 | 2200 | 1500 | 1500 | 1500 |
| cords | | | | | |
| Shock burst resistance | 100 | 120 | 100 | 120 | 120 |
| Steering stability | 120 | 13 0 | 140 | 120 | 125 |

| | EXAMPLE | EXAMPLE | EXAMPLE | EXAMPLE |
|---|---|---|---|---|
| | 6 | 7 | 8 | 9 |
| Type of organic fiber material | PET | PET | PET | PET |
| Elongation at break EB (%) of | 30 | 30 | 30 | 30 |
| carcass cords | | | | |
| CAP 300% Modulus MD | 8 | 8 | 8 | 8 |
| 40 × MD 20 × EB | 920 | 920 | 920 | 920 |
| Average to tai gauge GC | 9.5 | 9.5 | 11 | 9.5 |
| 60 × GC + 40 × MD + 20 × EB | 1490 | 1490 | 1580 | 1490 |
| Intermediate elongation EM | 4 | 4 | 4 | 4 |
| (%) ofcarcass cords | | | | |
| Standard amount fineness CF | 4500 | 4500 | 4500 | 9000 |
| ofcarcass cords | | | | |
| Twist coefficient CT ofcarcass | 1500 | 2200 | 2200 | 2200 |
| cords | | | | |
| Shock burst resistance | 12 0 | 120 | 110 | 120 |
| Steering stability | 125 | 125 | 105 | 125 |

As shown in Tables 1 and 2, compared to the pneumatic tires of the Conventional Example, the pneumatic tires of Comparative Examples 1 to 5 did not show sufficient evaluation results. On the other hand, better evaluation results were obtained from the pneumatic tires of Examples 1 to 9 than from the pneumatic tires of Conventional Example and Comparative Examples 1 to 5. In other words, at least performing under conditions identical to those for the pneumatic tires of Examples 1 to 9 leads to equivalent or higher evaluation results regardless of the use of PET fiber cords or rayon fiber cords.

1-5. (canceled)

6. A pneumatic tire comprising:
a tread portion extending in a tire circumferential direction and having an annular shape;
a pair of sidewall portions respectively disposed on both sides of the tread portion;
a pair of bead portions each disposed on an inner side of the sidewall portion in a tire radial direction; and
at least one carcass layer spanning between the pair of bead portions,
the carcass layer comprising carcass cords formed of organic fiber cords obtained by intertwining a bundle of filaments of organic fibers, and comprising turn-up portions respectively formed by being turned back at an end portion of the pair of bead portions to an outer side in a tire width direction,
the carcass cord having an elongation at break EB of 15% or more, a cap tread rubber compound of the tread portion having a 300% modulus MD of 4 MPa≤MD≤13 MPa, and the elongation at break EB and the 300% modulus MD being such that 600≤40×MD+20×EB (%)≤1300.

7. The pneumatic tire according to claim 6, further comprising:
a plurality of belt layers disposed on an outer side of the carcass layer in the tire radial direction, wherein
the tread portion comprises a pair of center main grooves extending in the tire circumferential direction with a tire equator line interposed between the center main grooves, and a center land portion defined by the pair of center main grooves, and
the center land portion located within 10% of a width of a second widest belt of the belt layers on each of a left side and a right side of a tire equatorial plane in the tire width direction has an average total gauge GC satisfying 5 mm≤GC≤10 mm, and
the average total gauge GC, the 300% modulus MD, and the elongation at break EB are such that 1100≤60×GC+40×MD+20×EB (%)≤1600.

8. The pneumatic tire according to claim 6, wherein
the carcass cords have, under a load of 1.0 cN/dtex, an intermediate elongation EM satisfying EM≤5.0%.

9. The pneumatic tire according to claim 6, wherein
the carcass cords have a standard amount fineness CF satisfying 4000 dtex≤CF≤8000 dtex.

10. The pneumatic tire according to claim 6, wherein
the carcass cords have, after dip treatment, a twist coefficient CT satisfying CT≥2000 (T/dm)×dtex^{0.5}.

11. The pneumatic tire according to claim 7, wherein
the carcass cords have, under a load of 1.0 cN/dtex, an intermediate elongation EM satisfying EM≤5.0%.

12. The pneumatic tire according to claim 11, wherein
the carcass cords have a standard amount fineness CF satisfying 4000 dtex≤CF≤8000 dtex.

13. The pneumatic tire according to claim 12, wherein
the carcass cords have, after dip treatment, a twist coefficient CT satisfying CT≥2000 (T/dm)×dtex^{0.5}.
